(19) United States
(12) Patent Application Publication
(10) Pub. No.: US 2024/0211544 A1
(43) Pub. Date: Jun. 27, 2024

(54) SYSTEM AND METHOD FOR AUTOMATICALLY ASSESSING CHANGE REQUESTS

(71) Applicant: Walmart Apollo, LLC, Bentonville, AR (US)

(72) Inventors: Anirban Chatterjee, Bangalore (IN); Kunal Banerjee, Bengaluru (IN); Binay Kumar Gupta, Kolkata (IN); Lalitdutt Parsai, Indore (IN); Vudata Geet Sameer, Bengaluru (IN)

(73) Assignee: Walmart Apollo, LLC, Bentonville, AR (US)

(21) Appl. No.: 18/088,150

(22) Filed: Dec. 23, 2022

(51) Int. Cl. G06F 18/21; G06F 18/22; G06N 20/20

(52) U.S. Cl. CPC G06F 18/217; G06F 18/22; G06N 20/20

(57) ABSTRACT

A method can include determining a training dataset for a first machine learning module based on historical change data by detecting and correcting correctable label noises in the historical change data and after detecting and correcting the correctable label noises, determining the training dataset based on a label-error-free portion of the historical change data. The method further can include training the first machine learning module based on the training dataset to determine a respective risk score associated with a respective change request. The method additionally can include determining, via the first machine learning module, as trained, a first risk score associated with a first change request. Further, the method can include determining a change approval based on the first risk score and a risk threshold. Then, the method can include transmitting the change approval to cause an implementation of the first change request. Other embodiments are disclosed.

### TECHNICAL FIELD

This disclosure relates generally to techniques for facilitating change management.

### BACKGROUND

Managing changes, such as upgrades and/or updates, to any production systems would pose challenges to organizations and their system support teams. Any malfunctions or downtime in a production system can result in significant damages to an organization. Most organizations thus adopt change management procedures to ensure risks associated with any requested changes are assessed before implementation. However, for large-scale technology driven organizations, the change requests submitted can be too voluminous and burdensome for reviewers to evaluate. Therefore, systems and methods for automatically assessing and approving change requests are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a system for assessing and approving change requests, according to an embodiment;

FIG. 4 illustrates a flow chart for a method for assessing and approving change requests, according to an embodiment; and

FIG. 5 illustrates a flow chart for a method for preparing a training dataset for a machine learning module in FIG. 4, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

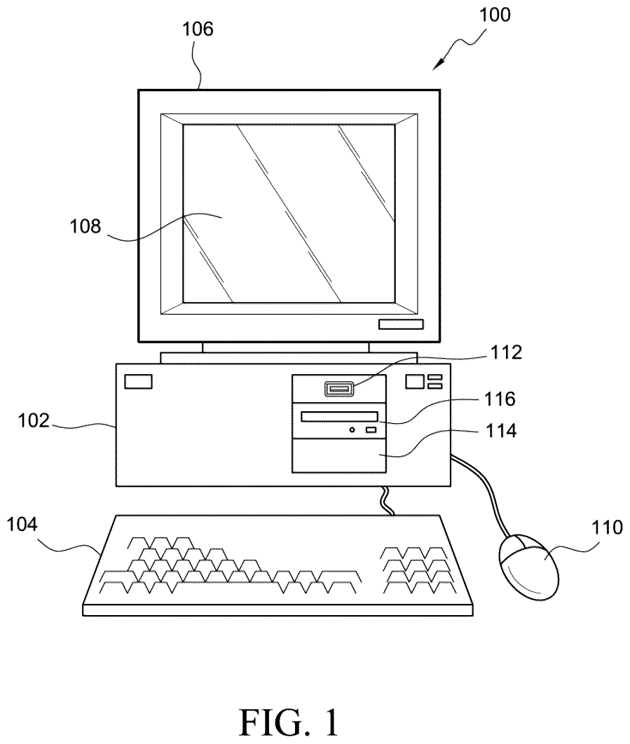

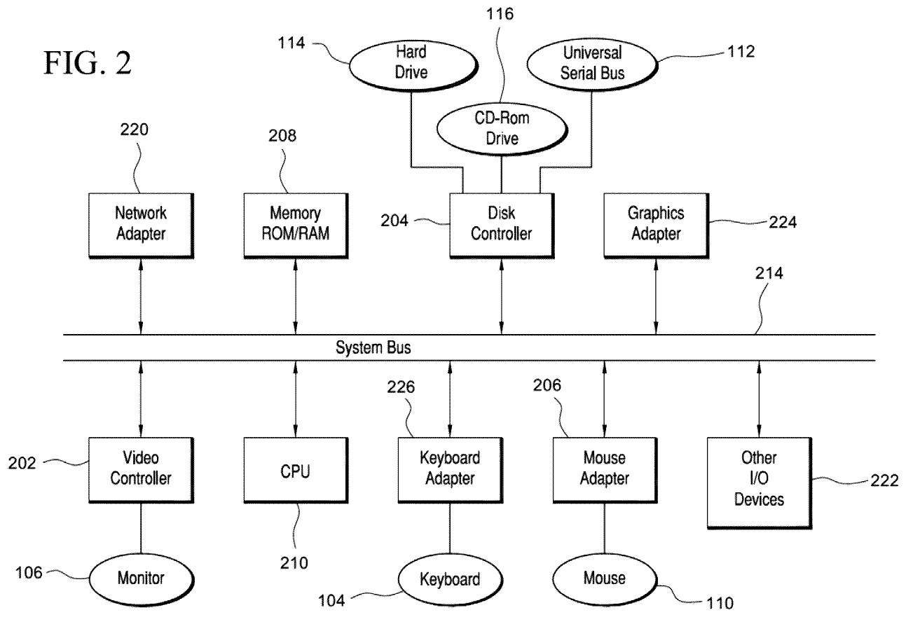

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refers to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 100) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICS.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such Block as a smartphone. In certain additional embodiments, computer system 100 may comprise an embedded system.

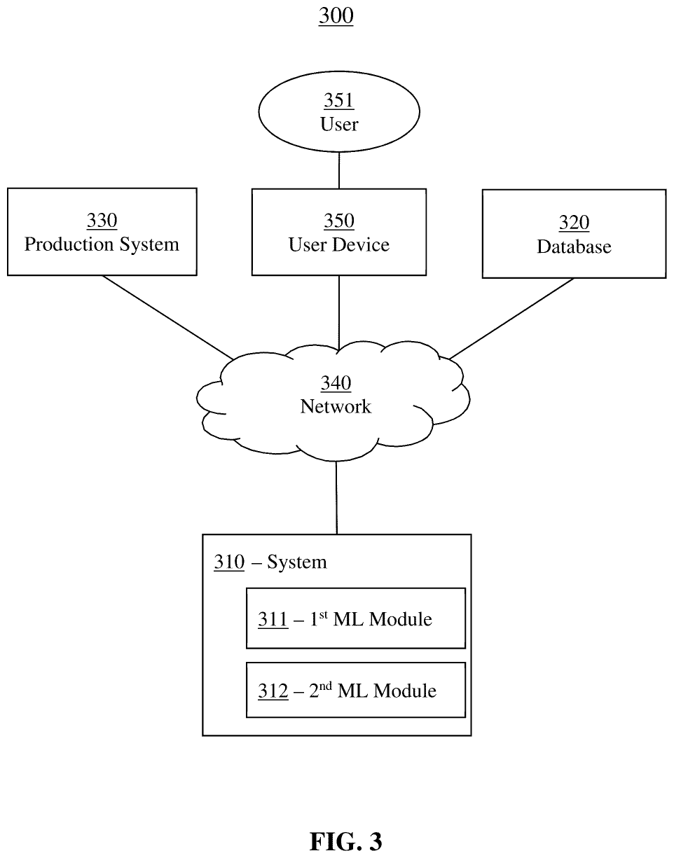

Turning ahead in the drawings, FIG. 3 illustrates a block diagram for a system 300, according to an embodiment. In many embodiments, system 300 comprises one or more systems (e.g., a system 310), one or more databases (e.g., a database 320), one or more production systems (e.g., a production system 330), one or more computer networks (e.g., a network 340), and/or one or more user devices (e.g., a user device 350) for one or more users (e.g., a user 351). In a number of embodiments, system 310 can be configured to assess a risk associated with a request for a change to production system 330 and approve or deny such request. In some embodiments, system 310 further can include one or more machine learning (ML) modules (e.g., a 1^{st} ML Module 311, a 2^{nd} ML Module 312, etc.) pre-trained and/or configured to be trained to perform various activities.

Systems 300 and 310 are merely exemplary, and embodiments of systems 300 and 310 are not limited to the embodiments presented herein. Systems 300 and 310 can be employed in many different embodiments or examples not specifically depicted or described herein. In many embodiments, systems 300 and 310 can comprise one or more suitable systems, subsystems, servers, modules, or models. In some embodiments, certain elements, modules, or systems of systems 300 and 310 can perform various procedures, processes, and/or activities. In other embodiments, the procedures, processes, and/or activities can be performed by other suitable elements, modules, or systems of systems 300 and 310. Systems 300 and 310 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of systems 300 and 310 described herein. Additional details regarding system 310, 1^{st} ML module 311, 2^{nd} ML module 312, database 320, production system 330, and/or user device 350 are described herein.

In some embodiments, system 310 and/or each of its modules (e.g., 1^{st} ML module 311 and/or 2^{nd} ML module 312) can be modules of computing instructions (e.g., software modules) stored at non-transitory computer readable media that operate on one or more processors. In these or other embodiments, system 310 and/or each of its modules can be implemented in hardware or combination of hardware and software. In many embodiments, the operator and/or administrator of system 310 can manage system 310, the processor(s) of system 310, and/or the memory storage unit(s) of system 310 using the input device(s) and/or display device(s) of system 310.

In a number of embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

System 300, system 310, database 320, production system 330, and/or user device 350 can be implemented using any suitable manner of wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can be in data communication, through network 340, with production system 330 and/or user device 350. Network 340 can include one or more of a computer network, a telephone network, the Internet, and/or an internal network not open to the public (e.g., a private network and/or a virtual private network (VPN)), etc.

Meanwhile, in many embodiments, system 310 also can be configured to communicate with one or more databases (e.g., database 320). Examples of the one or more databases can include a training dataset database for storing historical, processed, and/or synthesized data for training one or more machine learning modules (e.g., 1^{st} ML module 311 and/or 2^{nd} ML module 312), a model repository database for storing configurations and/or parameters for configuring and/or operating one or more systems (e.g., system 310 and/or production system 330) and/or modules (e.g., 1^{st} ML module 311 and/or 2^{nd} ML module 312), and so forth.

In some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units. Further, the one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, RocksDB, and IBM DB2 Database.

In a number of embodiments, production system 330 can be a front-end system or a back-end system. For example, production system 330 can host one or more websites and/or mobile application servers that interface with an application (e.g., a mobile application, a web browser, or a chat application) on a consumer device for a consumer (not shown) or on user device 350 for user 351. In other examples, production system 330 can support back-office applications, including receiving inputs from front-end systems, managing orders, inventory, and/or supply, processing payments, and so forth.

In some embodiments, user device 350 can be used by one or more users (e.g., user 351) to interface with system 310 and/or production system 330. For example, user device 350 can, via various user interfaces (e.g., webpages or applications, etc.), transmit commands from user 351 to system 310 and/or production system 330, and receive responses and/or notices from system 310 and/or production system 330 to be presented to user 351. In certain embodiments, user device 350 can be desktop computers, laptop computers, mobile devices, and/or other endpoint devices used by one or more users (e.g., user 351). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

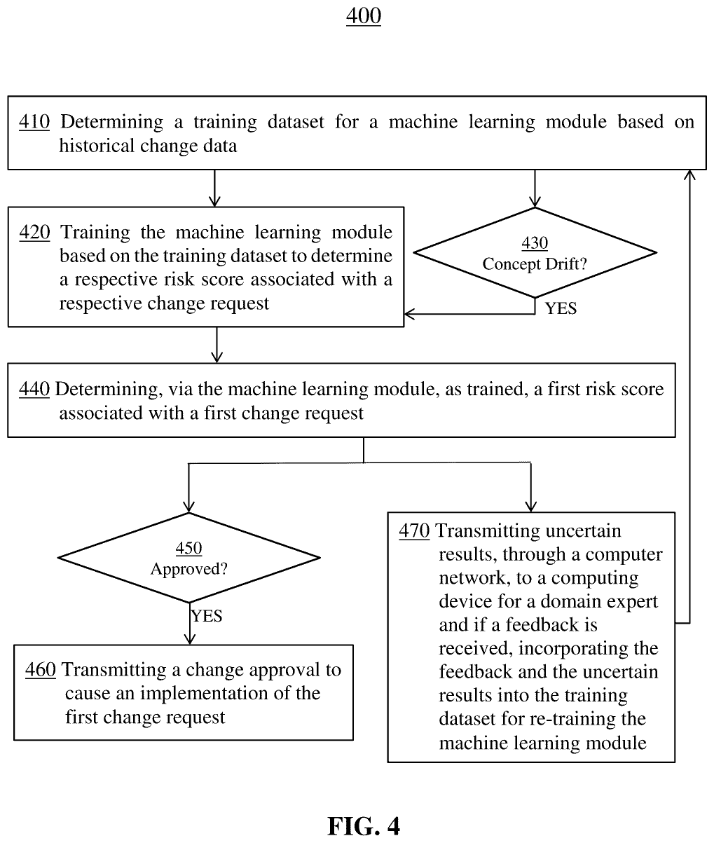

Turning ahead in the drawings, FIG. 4 illustrates a flow chart for a method 400 for assessing change requests, according to an embodiment. In many embodiments, method 400 can be implemented via execution of computing instructions on one or more processors. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) (including the modules) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3) (including the modules). The processor(s) can be similar or identical to the processor(s) described above with respect to computer system 100 (FIG. 1).

In many embodiments, method 400 can include determining a training dataset for a machine learning module (e.g., 1^{st} ML module 311 (FIG. 3) or 2^{nd} ML module 312 (FIG. 3)) based on historical change data (block 410). Examples of the machine learning module can include any suitable machine learning algorithms or models (e.g., one or more of a one-class Support Vector Machine (SVM), isolation forest, logistic regression, deep neural network, and/or gradient-boosted decision tree (XGBoost) model, etc.). The training dataset can include some or all of the historical change data with various labels, attributes, and/or features.

In some embodiments, the historical change data can include various issues, such as missing or incorrect feature values, class imbalance (e.g., significantly more normal change requests than risky change requests being submitted and/or approved), and/or gradual changes in data distribution, etc. Accordingly, determining the training dataset in block 410 further can include one or more procedures, processes, activities, and/or blocks to address some or all of these issues and improve the quality of the training dataset. The historical change data and/or the training dataset, as determined in block 410, can be stored in one or more databases (e.g., database 320 (FIG. 3)).

In a number of embodiments, method 400 further can include training the machine learning module (e.g., 1^{st} ML module 311 (FIG. 3)) based on the training dataset, as determined in block 410, to determine a respective risk score (e.g., a number between 0 and 1, 5, or 10, or a percentage, etc.) associated with a respective change request (e.g., a request to upgrade a software system of production system 330 (FIG. 3)) (block 420). Block 420 can include training the machine learning module in repeated cycles (e.g., daily, weekly, bi-weekly, monthly, etc.). The respective risk score further can be classified into one or more classes (e.g., a risky class and a normal or non-risky class). The respective change request can be received, via a network (e.g., network 340 (FIG. 3)), from a user device (e.g., user device 350 (FIG. 3)) for a user (e.g., user 351 (FIG. 3), a system operator, or an administrator). In many embodiments, method 400 further can include determining, via the machine learning module (e.g., 1^{st} ML module 311 (FIG. 3)), as trained in block 420, the respective risk score associated with the change request (block 430).

In some embodiments, method 400 further can include detecting a concept drift in the training dataset, as determined in block 410, relative to a prior training dataset (block 430). Concept drift generally refers the change in the joint probability distribution for input and output data over time. Detecting the concept drift in the training dataset can include comparing the data distribution of the training dataset with the data distribution of a prior training dataset. Indeed, detecting concept drifts in block 430 can be implemented based on any suitable algorithms, such as one or more of the Page-Hinkely (PH) method, the Drift Detection Method (DDM), the Early Drift Detection Method (EDDM), Hoeffding's inequality-based Drift Detection Method (HDDM) (and/or its variants HDDMA and HDDMw), ADaptive WINdowing (ADWIN), Kolmogorov-Smirnov (KS) test, and/or Kolmogorov-Smirnov WINdowing (KSWIN), etc. In many embodiments, block 430 of method 400 further can determine whether the concept drift exceeds an acceptable limit or a concept drift threshold.

In a number of embodiments, block 430 can detect, via a concept drift detector based on one or more of the above-mentioned methods, the concept drift between two samples with data points, S₁ and S₂, from a data stream and predict the concept drift. For example, the concept drift detector can be a modified Kolmogorov-Smirnov (KS) test based on the concept drift in each feature (I),) between two multi-variate samples. The overall concept drift can be determined by

$${D}_{final} = \frac{1}{K} {\sum }_{i = 1}^{K} {w}_{i} {D}_{i} ,$$

wherein K is the number of features and wᵢ is the importance or weight of the i^{th} feature. In some embodiments, the importance or weight wᵢ in the equation can be determined manually (e.g., by user 351 (FIG. 3)) or generated based on any suitable machine learning modules (e.g., XGBoost, 1^{st} ML module 311 (FIG. 3), or 2^{nd} ML module 312 (FIG. 3), etc.), which can be similar to or different from the machine learning module in block 420.

In another example, the concept drift detector can be an ensemble drift detector based on multiple concept drift detecting algorithms mentioned above (CDₚ, 1≤p≤N), and the prediction of a concept drift detector can be either −1 (no concept drift detected) or 1 (a concept drift detected). The overall prediction of concept drift (Φ(S₁, S₂)) can be represented by a formula:

$$Φ ( {S}_{1} , {S}_{2} ) = \frac{1}{N} {\sum }_{p = 1}^{N} {CD}_{p} ( {S}_{1} , {S}_{2} ) .$$

Examples of the ensemble drift detector can include a majority voting-based ensemble of the ADWIN, HDDMA, and KSWIN methods; a majority voting-based ensemble of the HDDMA, HDDMw, and Page-Hinkley methods; and so forth. In embodiments where the prediction of each concept drift detector (CDₚ) is either −1 or 1, the overall prediction can be a number between −1 and 1. In a number of embodiments that adopt concept drift detecting techniques as described here, the acceptable limit or concept drift threshold can be zero or any positive number that is not greater than 1.

In many embodiments, upon determining in block 430 that the concept drift is above a concept drift threshold, block 430 additionally can include triggering an out-of-cycle re-training of the machine learning module in block 420 based on the updated training dataset incorporating the concept drift since the previous training cycle. The concept drift threshold can be determined based on the concept drift detector adopted. For example, the concept drift threshold for the modified KS test can be 0.9, or 0.95, etc., and the concept drift threshold for the ensemble drift detector can be 0.25, 0.5, or 0.9, etc. In certain embodiments, the concept drift threshold can be zero so that whenever a concept drift is detected, block 430 will cause the out-of-cycle training. In some embodiments, the more-recent-in-time data points of the updated training datasets for the machine learning module in block 420 can be assigned greater weights relative to the weights assigned to the less-recent-in-time data points of the updated training dataset.

The proactive approach in block 430 is advantageous because training the machine learning module in each cycle can be resource consuming which makes frequent training in block 420 impractical. With concept drift detecting in block 430, method 400 can balance between consuming resources for training the machine learning module to update the module and maintaining the performance of the machine learning module, as trained.

In many embodiments, after training the machine learning module in block 420, method 400 further can include determining, via the machine learning module (e.g., 1^{st} ML module 311 (FIG. 3) or 2^{nd} ML module 312 (FIG. 3)), as trained in block 420, a first risk score associated with a first change request (block 440). In a number of embodiments, method 400 further can include determining a change approval (e.g., whether the first change request can be approved) (blocked 450) based on the first risk score and an acceptable risk threshold (e.g., 0.5, or any suitable and/or tunable risk threshold values). In some embodiments, the first risk score can include multiple scores corresponding to the respective risks in various aspects (e.g., the overall risk, the impact to the production system (e.g., production system 320 (FIG. 3)), the planned outage, the complexity of implementation, the impact to service, or the risk of implementation, etc.), and the acceptable risk threshold also can include multiple threshold values corresponding to the respective risks in various aspects. In similar or different embodiments with multiple scores and threshold values in various aspects, whether the first change request can be approved based on the first risk score and the acceptable risk threshold can be determined based on a majority voting or weighted majority voting rule among the various aspects.

In a number of embodiments, method 400 further can include transmitting, via a network (e.g., network 340 (FIG. 3)), the change approval to cause an implementation of the first change request on the production system (e.g., production system 320 (FIG. 3)) (block 460). In a few embodiments, block 460 transmits the change approval to the requester (e.g., user 351 (FIG. 3), a system operator, or an administrator, etc.) and allow the requester to arrange the implementation of the change request, including scheduling the implementation and/or announcing the outage of system to end users, etc. In certain embodiments, the implementation of the change request can be automatically scheduled to be performed immediately or in a batch with other approved change requests.

In some embodiments, method 400 further can include transmitting uncertain results, through the computer network (e.g., network 340 (FIG. 3)), to a computing device (e.g., user device 350 (FIG. 3)) for a domain expert (e.g., user 351 (FIG. 3)) and if a feedback is received, via the computer network from the computing device, incorporating the feedback from the domain expert and the uncertain results into the training dataset for re-training the machine learning module (block 470). The uncertain results transmitted to the domain expert can include one or more change-risk combinations of the multiple change requests and the risk scores associated with the multiple change requests, selected based on a respective predictive uncertainty of each of the risk scores. In a number of embodiments, method 400 further can include, in block 470, determining the uncertain results to be reviewed by the domain expert based on the risk scores determined in block 440 in a certain period of time (e.g., a week, a month, etc.). In many embodiments, block 470 can be repeated periodically, and the uncertain results can be collected in a current feedback cycle (e.g., in the past week or past month, etc.) and transmitted to the domain expert.

In several embodiments, the uncertain results further can be determined or selected based on a ranking (e.g., top 10, 20, 30, etc.) of the respective predictive uncertainty for each of risk scores associated with the change requests. In a few embodiments, the respective predictive uncertainty for each of the risk scores can be determined based at least in part on a posterior predictive distribution for the risks scores. For example, the respective predictive uncertainty can be estimated based on a model within standard Bayesian ensemble-based framework. Under this framework, uncertainty in predictions due to knowledge uncertainty is expressed as the level of spread, or “disagreement”, of models in the ensemble, and the expected knowledge uncertainty can be obtained by examining the diversity of predictions.

An exemplary formula can be used to determine the expected knowledge uncertainty in an ensemble based on the difference between the entropy (H) of the predictive posterior (a measure of the total uncertainty) and the expected entropy of each model in the ensemble (a measure of the data uncertainty):

$$I [ y , θ \vert x , D ] = H [ P ( y \vert x , D ) ] - {E}_{p ( θ \vert D )} [ H [ P ( y \vert x , θ ) ] ] \approx H [ \frac{1}{M} {\sum }_{m = 1}^{M} H [ P ( y \vert x ; {θ}^{( m )} ) ]$$

Here, y represents a predicted risk score; x represents the feature-set corresponding to y; θ represents the model parameters; D represents the training dataset for the machine learning module in blocks 410, 420, and 440; M represents the total number of models in the ensemble (e.g., the total number of trees constructed by XGBoost); and P(y|x, D) of a model represents the total uncertainty of the model. In certain embodiments, the respective predictive uncertainty for each of risk scores can be determined based on the expected knowledge uncertainty.

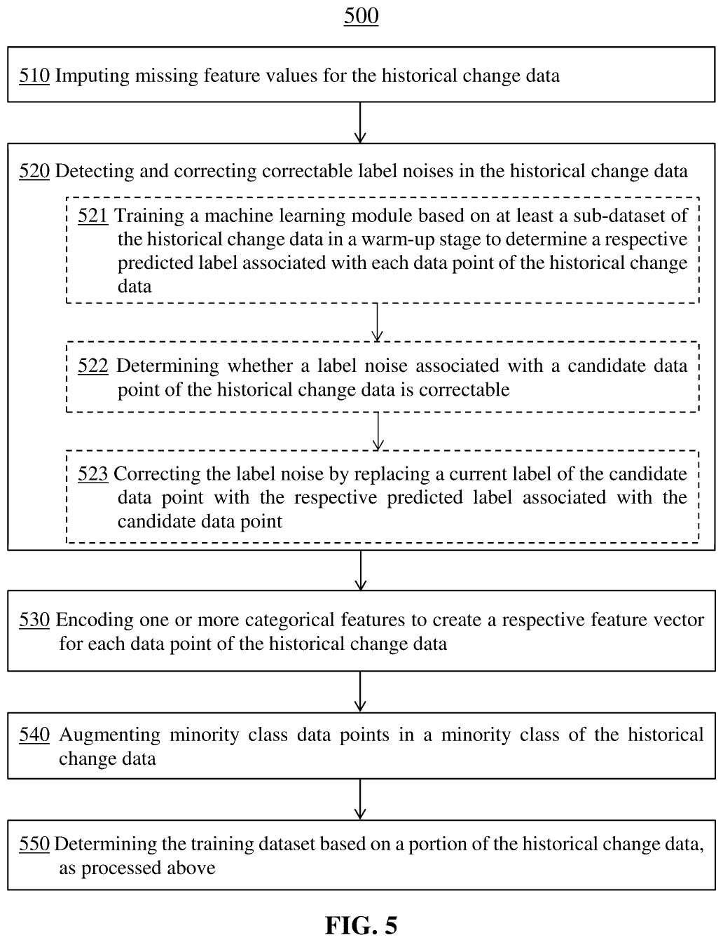

Turning ahead in the drawings, FIG. 5 illustrates a flow chart for a method 500 for determining a training dataset for a machine learning module in FIG. 4, according to an embodiment. In many embodiments, method 500 can be implemented via execution of computing instructions on one or more processors. Method 500 is merely exemplary and is not limited to the embodiments presented herein. Method 500 can be employed in many different embodiments or examples not specifically depicted or described herein. In some embodiments, the procedures, the processes, the activities, and/or the blocks of method 500 can be performed in the order presented. In other embodiments, the procedures, the processes, the activities, and/or the blocks of method 500 can be performed in any suitable order. In still other embodiments, one or more of the procedures, the processes, the activities, and/or the blocks of method 500 can be combined or skipped.

In many embodiments, system 300 (FIG. 3) and/or system 310 (FIG. 3) (including the modules thereof) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3) (including the modules). The processor(s) can be similar or identical to the processor(s) described above with respect to computer system 100 (FIG. 1).

In a number of embodiments, method 500 can include imputing missing feature values for the historical change data (block 510). Not all historical change data are perfect. Indeed, it is common that data points (e.g., tabular data) of the historical change data comprise some missing feature values. If the degree of sparsity for certain feature values is high, the performance of the machine learning module (e.g., 1^{st} ML module 311 (FIG. 3), 2^{nd} ML module 312 (FIG. 3), or the machine learning module in FIG. 4) trained by the historical change data can be hindered. As such, it is advantage to include block 510 to impute the missing feature values based on any suitable methods in method 500. Examples of value imputing methods can include imputation by the mean, median, or highest occurring (mode) value, a constant value zero, linear regression based on existing feature values for the historical change data, complex model-based imputation methods (e.g., MINWAE by Pierre-Alexandre Mattei et al.), k-nearest neighbors (kNN), iterative imputer, soft impute, and optimal transport, etc.

In many embodiments, method 500 further can include detecting and correcting correctable label noises in the historical change data (block 520), based on any suitable methods. Label noises can be introduced into the historical change data for various reasons. Some examples can include errors in feature values imputed (e.g., block 510), in particularly when the degree of data sparsity is high. Another example can be that the outcomes did not reflect the risks in some change requests in the historical change data due to human intervention during prior change implementations. Risky changes implemented on production systems generally are closely monitored under change management processes, and failures in production associated with risky change requests that could have happened are often avoided or mitigated.

In some embodiments, detecting and correcting label noises in block 520 can include training a machine learning module (e.g., XGBoost, SVM, Neural Network, 1^{st} ML module 311 (FIG. 3), 2^{nd} ML module 312 (FIG. 3), etc.) based on at least a sub-dataset of the historical change data in a warm-up stage to determine a respective predicted label associated with each data point of the historical change data (block 521). The machine learning module in block 521 can be similar to or different from the machine learning module in method 400 (FIG. 4). To distinguish these machine learning modules, the machine learning module in method 400 (FIG. 4) hereinafter can be referred to as the first machine learning module while the machine learning module in block 521 can be referred to as the second machine learning module.

In a number of embodiments, the sub-dataset for training the second machine learning module in block 521 can include historical data points that comprise label errors existing in the original feature values or introduced in the feature values imputed in block 510. In certain embodiments, the sub-dataset can include some (e.g., one third, a half, or two thirds, etc.) of the historical data points while the rest of the historical data points are used as validation data. In some embodiments, the warm-up stage can include multiple (e.g., 20, 30, etc.) iterations for training the second machine learning module in block 521.

In several embodiments, detecting and correcting the correctable noises in block 520 further can include determining whether a label noise associated with a candidate data point of the historical change data is correctable (block 522). Determining whether the label noise associated with the candidate data point of the historical change data is correctable in block 522 can be based on a confident data range of the historical change data and a prediction confidence for the respective predicted label associated with the candidate data point. In some embodiments, the label noise can be determined in block 522 to be correctable when (a) the candidate data point is in the confident data range of the historical change data, and (b) the prediction confidence for the respective predicted label is at least as great as a confidence threshold (e.g., 0.3).

A label noise associated with a candidate data point of the historical change data can be determined to be correctable when the candidate data point is in a “confident data range” of the historical change data (e.g., 0.3). In a number of embodiments, it can be assumed that in noisy data, there exists the confident data range in which the second machine learning module (e.g., a noisy classifier f) can produce highly confident and trustworthy predictions which are consistent with the clean “Bayes optimal classifier”.

In some embodiments, the trustworthiness of the second machine learning module can be determined based at least in part on a prediction confidence or an estimated score (e.g., 0.5) for the second machine learning module (e.g., probabilities from the softmax layer of a neural network, a distance to the separating hyper-plane in support vector classification, or mean class probabilities for the trees in a random forest, etc.). Determining whether a label noise associated with a candidate data point in block 522 further can include determining the confident data range of the historical change data based at least in part on a distribution of prediction confidence for predicted labels (e.g., 0.5) that are associated with the historical change data and determined by the second machine learning module, as trained in the warm-up stage (e.g., block 521). Upon determining the confident data range, block 522 can include determining that the label noise associated with a candidate data point that falls in the confident data range of the historical change data is correctable.

In many embodiments, detecting and correcting the correctable label noises in block 520 further can include, after determining that the label noise associated with a candidate data point is correctable in block 523, correcting the label noise by replacing a current label of the candidate data point with the respective predicted label associated with the candidate data point (block 523). An exemplary method for correcting label noises in block 523 can be a Progressive Label Correction method that iteratively corrects label noises.

In several embodiments, after label noise correcting, candidate data points with correctable label errors can become significantly, or at least relatively (compared to unprocessed data points), “label-error-free”. These candidate data points can constitute a label-error-free portion of the historical change data (e.g., a portion of the historical change data that is relatively free of label errors). In certain embodiments, data points that are not in the confident data range of the historical change data can be discarded and excluded from being included or considered for the training dataset (e.g., the training set for the first machine learning module in method 400 (FIG. 4)), and thus all of the candidate data points remain in the historical change data can constitute the label-error-free portion. In embodiments including determining a training dataset for a machine learning module based on the historical change data (e.g., block 410 (FIG. 4)), determining the training dataset further can include, after detecting and correcting the correctable label noises (e.g., block 520), determining the training dataset based on the label-error-free portion of the historical change data.

In a number of embodiments, method 500 further can include encoding one or more categorical features to create a respective feature vector for each data point of the historical change data (block 530). Block 530 can be performed after block 520, and the historical change data in block 530 can be the label-error-free portion of the historical change data, as processed in block 520. In some embodiments, encoding the one or more categorical features in block 530 further can include applying different encoding techniques for different categorical features for each data point of the historical change data. For example, a first encoding technique (e.g., label encoding) can be used to encode a first categorical feature of the one or more categorical features, and a second encoding technique (e.g., one-hot encoding) that is different from the first encoding technique can be used to encode a second categorical feature of the one or more categorical features.

In many embodiments, method 500 additionally can include augmenting minority class data points in a minority class of the historical change data (block 540). The historical change data can be categorized into two or more classes (e.g., risky vs. non-risky, low risk vs. medium risk vs. high risk, etc.). Data imbalance also can be an issue in the historical change data. For example, risky change requests can be less frequently submitted and/or approved, and consequentially, the number of data points associated with risky change requests would be significantly less than that for non-risky change requests. If the data imbalance issue is not addressed, a machine learning module trained based on an imbalanced training dataset can be biased and cannot produce satisfying predictions. Augmenting the minority class data points in the minority class in block 540 can be implemented based on any suitable up-sampling techniques (e.g., Synthetic Minority Over-Sampling Technique (SMOTE), Generative Adversarial Network (GAN), Generative Adversarial Minority Oversampling (GAMO), etc.). Augmenting the minority class data points in the minority class in block 540 further can include generating new minority class data points of the minority class data points (e.g., generating samples by a convex generator) based on existing minority class data points of the minority class data points. In an exemplary embodiment, augmenting the minority class data points in block 540 also can include generating new minority class data points while determining a class boundary or periphery between the minority class and the other class(es). The new minority class data points, as generated, can be distributed toward the class periphery of the minority class.

In a number of embodiments, method 500 further can include determining the training dataset based on a portion of the historical change data, as processed in blocks 510, 520, 530, and/or 540 (block 550). The portion of the historical change data to be included in the training dataset in block 550 can included data points that comprise imputed feature values (e.g., block 510), label errors corrected (e.g., block 520), and/or respective feature vectors (e.g., block 530), and/or that are synthesized (e.g., block 540).

Various embodiments can include a system for automatically assessing and approving change requests. The system can include one or more processors and one or more non-transitory computer-readable media storing computing instructions that, when executed on the one or more processors, cause the one or more processors to perform various acts. In many embodiments, the acts can include determining a training dataset for a first machine learning module based on historical change data by detecting and correcting correctable label noises in the historical change data and after detecting and correcting the correctable label noises, determining the training dataset based on a label-error-free (relatively speaking) portion of the historical change data.

In some embodiments, detecting and correcting correctable label noises in the historical change data can be performed based at least in part on training a second machine learning module based on at least a sub-dataset of the historical change data in a warm-up stage to determine a respective predicted label associated with each data point of the historical change data; after determining, by the second machine learning module, the respective predicated label associated with each data point of the historical change data, determining whether a label noise associated with a candidate data point of the historical change data is correctable based on a confident data range of the historical change data and a prediction confidence for the respective predicted label associated with the candidate data point; and upon determining that the label noise associated with the candidate data point of the historical change data is correctable, correcting the label noise by replacing a current label of the candidate data point with the respective predicted label associated with the candidate data point.

In some embodiments, the act of detecting and correcting the correctable label noises in the historical change data further can be based on determining the confident data range of the historical change data based at least in part on a distribution of prediction confidence for predicted labels that are associated with the historical change data and determined by the second machine learning module, as trained in the warm-up stage. In several embodiments, the act of determining whether the label noise associated with the candidate data point of the historical change data is correctable further can include determining that the label noise is correctable when (a) the candidate data point is in the confident data range of the historical change data, and (b) the prediction confidence for the respective predicted label is at least as great as a confidence threshold.

In a number of embodiments, the act of determining the training dataset for the first machine learning module further can include one or more of: (a) imputing missing feature values for the historical change data; (b) encoding one or more categorical features of respective features for each data point of the historical change data to create a respective feature vector for the each data point; or (c) augmenting minority class data points in a minority class of the historical change data. In a few embodiments, imputing the missing feature values for the historical change data further can include applying linear regression based on existing feature values for the historical change data. Encoding the one or more categorical features of the respective features for each data point further can include applying a first encoding technique to encode a first categorical feature of the one or more categorical features and a second encoding technique to encode a second categorical feature of the one or more categorical features. The first encoding technique can be similar to or different from the second encoding technique. In certain embodiments, augmenting the minority class data points in the minority class further can include generating new minority class data points of the minority class data points based on existing minority class data points of the minority class data points, wherein the new minority class data points, as generated, are distributed toward a class periphery of the minority class.

In a number of embodiments, the acts further can include training the first machine learning module based on the training dataset to determine a respective risk score associated with a respective change request. The acts additionally can include determining, via the first machine learning module, as trained, a first risk score associated with a first change request. Moreover, the acts can include determining a change approval based on the first risk score and a risk threshold. Further, the act can include transmitting the change approval to cause an implementation of the first change request.

In many embodiments, the acts further can include detecting a concept drift in the training dataset relative to a prior training dataset; and upon determining that the concept drift is above a concept drift threshold, re-training the first machine learning module based on the training dataset associated with the concept drift. The act of detecting the concept drift in the training dataset relative to the prior training dataset further can include comparing a data distribution of the training dataset with a data distribution of the prior training dataset. In some embodiments, the act of re-training the first machine learning module based on the training dataset associated with the concept drift additionally can include assigning a respective weight to each data point of the training dataset. The respective weight for a more-recent-in-time data point of the training dataset can be higher relative to the respective weight for a less-recent-in-time data point of the training dataset. The act of re-training the first machine learning module further can be based on the respective weight for each data point of the training dataset.

In a number of embodiments, the acts also can include after determining, by the first machine learning module, risk scores associated with multiple change requests, transmitting uncertain results, through a computer network, to a computing device for a domain expert. In addition, the acts can include upon receiving, via the computing device through the computer network, feedback from the domain expert, incorporating the feedback and the uncertain results into the training dataset for re-training the first machine learning module.

Meanwhile, the uncertain results can include one or more change-risk combinations of the multiple change requests and the risk scores associated with the multiple change requests, selected based on a respective predictive uncertainty of each of the risk scores. The risk scores associated with the multiple change requests can be determined by the first machine learning module in a current feedback cycle. The uncertain results further can be determined based on a ranking of the respective predictive uncertainty for each of the risk scores. The respective predictive uncertainty for each of the risk scores can be determined based at least in part on a posterior predictive distribution for the risks scores.

Further, various embodiments can include a method being implemented via execution of computing instructions configured to run at one or more processors and stored at one or more non-transitory computer-readable media. The method can include one or more acts performed in the system above. For example, the method can include determining a training dataset for a first machine learning module based on historical change data by: detecting and correcting correctable label noises in the historical change data based at least in part on: training a second machine learning module based on a sub-dataset of the historical change data in a warm-up stage to determine a respective predicted label associated with each data point of the historical change data; after determining, by the second machine learning module, the respective predicated label associated with each data point of the historical change data, determining whether a label noise associated with a candidate data point of the historical change data is correctable based on a confident data range of the historical change data and a prediction confidence for the respective predicted label associated with the candidate data point; and upon determining that the label noise associated with the candidate data point of the historical change data is correctable, correcting the label noise by replacing a current label of the candidate data point with the respective predicted label associated with the candidate data point; and after detecting and correcting the correctable label noises, determining the training dataset based on an error-free portion of the historical change data.

The method further can include training the first machine learning module based on the training dataset to determine a respective risk score associated with a respective change request; determining, via the first machine learning module, as trained, a first risk score associated with a first change request; determining a change approval based on the first risk score and a risk threshold; and transmitting the change approval to cause an implementation of the first change request.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although automatically assessing and approving change requests has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. Different functions, algorithms, and/or machine learning modules may be used to impute missing feature values, detect and/or correct label noises, augment data points in a minority class, detect a concept drift, and/or determine the risk scores. Various training datasets can be used for training the machine learning modules described above.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to, when run on the one or more processors, cause the one or more processors to perform:
determining a training dataset for a first machine learning module based on historical change data by:
detecting and correcting correctable label noises in the historical change data based at least in part on:
training a second machine learning module based on at least a sub-dataset of the historical change data in a warm-up stage to determine a respective predicted label associated with each data point of the historical change data;
after determining, by the second machine learning module, the respective predicated label associated with each data point of the historical change data, determining whether a label noise associated with a candidate data point of the historical change data is correctable based on a confident data range of the historical change data and a prediction confidence for the respective predicted label associated with the candidate data point; and
upon determining that the label noise associated with the candidate data point of the historical change data is correctable, correcting the label noise by replacing a current label of the candidate data point with the respective predicted label associated with the candidate data point; and
after detecting and correcting the correctable label noises, determining the training dataset based on a label-error-free portion of the historical change data;
training the first machine learning module based on the training dataset to determine a respective risk score associated with a respective change request;
determining, via the first machine learning module, as trained, a first risk score associated with a first change request;
determining a change approval based on the first risk score and a risk threshold; and
transmitting the change approval to cause an implementation of the first change request.

2. The system in claim 1, wherein:
determining whether the label noise associated with the candidate data point of the historical change data is correctable further comprises determining that the label noise is correctable when (a) the candidate data point is in the confident data range of the historical change data, and (b) the prediction confidence for the respective predicted label is at least as great as a confidence threshold.

3. The system in claim 1, wherein:
detecting and correcting the correctable label noises in the historical change data is further based on determining the confident data range of the historical change data based at least in part on a distribution of prediction confidence for predicted labels that are associated with the historical change data and determined by the second machine learning module, as trained in the warm-up stage.

4. The system in claim 1, wherein determining the training dataset for the first machine learning module further comprises one or more of:
(a) imputing missing feature values for the historical change data;
(b) encoding one or more categorical features of respective features for each data point of the historical change data to create a respective feature vector for the each data point; or
(c) augmenting minority class data points in a minority class of the historical change data.

5. The system in claim 4, wherein one or more of:
(a) imputing the missing feature values for the historical change data further comprises applying linear regression based on existing feature values for the historical change data;
(b) encoding the one or more categorical features of the respective features for each data point further comprises applying a first encoding technique to encode a first categorical feature of the one or more categorical features and a second encoding technique to encode a second categorical feature of the one or more categorical features, the first encoding technique being different from the second encoding technique; or
(c) augmenting the minority class data points in the minority class further comprises generating new minority class data points of the minority class data points based on existing minority class data points of the minority class data points, wherein the new minority class data points, as generated, are distributed toward a class periphery of the minority class.

6. The system in claim 1, wherein the computing instructions are further configured to cause the one or more processors to perform:
detecting a concept drift in the training dataset relative to a prior training dataset; and
upon determining that the concept drift is above a concept drift threshold, re-training the first machine learning module based on the training dataset associated with the concept drift.

7. The system in claim 6, wherein detecting the concept drift in the training dataset relative to the prior training dataset further comprises comparing a data distribution of the training dataset with a data distribution of the prior training dataset.

8. The system in claim 6, wherein:
re-training the first machine learning module based on the training dataset associated with the concept drift further comprises assigning a respective weight to each data point of the training dataset,
wherein:
the respective weight for a more-recent-in-time data point of the training dataset is higher relative to the respective weight for a less-recent-in-time data point of the training dataset; and
re-training the first machine learning module is further based on the respective weight for each data point of the training dataset.

9. The system in claim 1, wherein the computing instructions are further configured to cause the one or more processors to perform:
after determining, by the first machine learning module, risk scores associated with multiple change requests, transmitting uncertain results, through a computer network, to a computing device for a domain expert, wherein:
the uncertain results comprise one or more change-risk combinations of the multiple change requests and the risk scores associated with the multiple change requests, selected based on a respective predictive uncertainty of each of the risk scores; and
upon receiving, via the computing device through the computer network, feedback from the domain expert, incorporating the feedback and the uncertain results into the training dataset for re-training the first machine learning module.

10. The system in claim 9, wherein one or more of:
the risk scores associated with the multiple change requests are determined by the first machine learning module in a current feedback cycle;
the uncertain results are further determined based on a ranking of the respective predictive uncertainty for each of the risk scores; or
the respective predictive uncertainty for each of the risk scores is determined based at least in part on a posterior predictive distribution for the risks scores.

11. A method being implemented via execution of computing instructions configured to run at one or more processors and stored at one or more non-transitory computer-readable media, the method comprising:
determining a training dataset for a first machine learning module based on historical change data by:
detecting and correcting correctable label noises in the historical change data based at least in part on:
training a second machine learning module based on a sub-dataset of the historical change data in a warm-up stage to determine a respective predicted label associated with each data point of the historical change data;
after determining, by the second machine learning module, the respective predicated label associated with each data point of the historical change data, determining whether a label noise associated with a candidate data point of the historical change data is correctable based on a confident data range of the historical change data and a prediction confidence for the respective predicted label associated with the candidate data point; and
upon determining that the label noise associated with the candidate data point of the historical change data is correctable, correcting the label noise by replacing a current label of the candidate data point with the respective predicted label associated with the candidate data point; and
after detecting and correcting the correctable label noises, determining the training dataset based on an error-free portion of the historical change data;
training the first machine learning module based on the training dataset to determine a respective risk score associated with a respective change request;
determining, via the first machine learning module, as trained, a first risk score associated with a first change request;
determining a change approval based on the first risk score and a risk threshold; and
transmitting the change approval to cause an implementation of the first change request.

12. The method in claim 11, wherein:
determining whether the label noise associated with the candidate data point of the historical change data is correctable further comprises determining that the label noise is correctable when (a) the candidate data point is in the confident data range of the historical change data, and (b) the prediction confidence for the respective predicted label is at least as great as a confidence threshold.

13. The method in claim 11, wherein:
detecting and correcting the correctable label noises in the historical change data is further based on determining the confident data range of the historical change data based at least in part on a distribution of prediction confidence for predicted labels that are associated with the historical change data and determined by the second machine learning module, as trained in the warm-up stage.

14. The method in claim 11, wherein determining the training dataset for the first machine learning module further comprises one or more of:
(a) imputing missing feature values for the historical change data;
(b) encoding one or more categorical features of respective features for each data point of the historical change data to create a respective feature vector for the each data point; or
(c) augmenting minority class data points in a minority class of the historical change data.

15. The method in claim 14, wherein one or more of:
(a) imputing the missing feature values for the historical change data further comprises applying linear regression based on existing feature values for the historical change data;
(b) encoding the one or more categorical features of the respective features for each data point further comprises applying a first encoding technique to encode a first categorical feature of the one or more categorical features and a second encoding technique to encode a second categorical feature of the one or more categorical features, the first encoding technique is different from the second encoding technique; or
(c) augmenting the minority class data points in the minority class further comprises generating new minority class data points of the minority class data points based on existing minority class data points of the minority class data points, wherein the new minority class data points, as generated, are distributed near a class periphery of the minority class.

16. The method in claim 11 further comprising:
detecting a concept drift in the training dataset relative to a prior training dataset; and
upon determining that the concept drift is above a concept drift threshold, re-training the first machine learning module based on the training dataset associated with the concept drift.

17. The method in claim 16, wherein detecting the concept drift in the training dataset relative to the prior training dataset further comprises comparing a data distribution of the training dataset with a data distribution of the prior training dataset.

18. The method in claim 16, wherein:
re-training the first machine learning module based on the training dataset associated with the concept drift further comprises assigning a respective weight to each data point of the training dataset,
wherein:
the respective weight for a more-recent-in-time data point of the training dataset is higher relative to the respective weight for a less-recent-in-time data point of the training dataset; and
re-training the first machine learning module is further based on the respective weight for each data point of the training dataset.

19. The method in claim 11 further comprising:
after determining, by the first machine learning module, risk scores associated with multiple change requests, transmitting uncertain results, through a computer network, to a computing device for a domain expert, wherein:
the uncertain results comprise one or more change-risk combinations of the multiple change requests and the risk scores associated with the multiple change requests, selected based on a respective predictive uncertainty of each of the risk scores; and
upon receiving, via the computing device through the computer network, feedback from the domain expert, incorporating the feedback and the uncertain results into the training dataset for re-training the first machine learning module.

20. The method in claim 19, wherein one or more of:
the risk scores associated with the multiple change requests are determined by the first machine learning module in a current feedback cycle;
the uncertain results are further determined based on one or more of:
a ranking of the respective predictive uncertainty for each of the risk scores; or
an uncertainty threshold for the respective predictive uncertainty for each of the risk scores; or
the respective predictive uncertainty for each of the risk scores is determined based at least in part on a posterior predictive distribution for the risks scores.
